(19) United States
(12) Patent Application Publication
(10) Pub. No.: US 2005/0254559 A1
(43) Pub. Date: Nov. 17, 2005

(54) Packet detection

(76) Inventors: Wen-Sheng Hou, Tao-Yuan Hsien (TW); Chien-Chen Lin, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,521

(22) Filed: May 11, 2004

(51) Int. Cl. H04B 1/707

(52) U.S. Cl. 375/150

(57) ABSTRACT

A method of packet detection includes obtaining a correlation of an input signal received by a receiver, detecting a peak power of the input signal, and determining if the packet is detected according to the correlation and the peak power of the input signal. The method improves the performance of packet detection and greatly decreases the number of packets lost and the number of false alarms.

### BACKGROUND OF INVENTION

1. Field of the Invention

The present invention relates to a detection method, and more particularly, a method of packet detection.

2. Description of the Prior Art

In a communication system, data is transmitted in the form of packets. However, when the data travels in a communication channel, such as in cables or over air, the data signal will be disturbed by noise. Therefore, the data that a receiver receives is not exactly as the original. The receiver receives the packet as well as noise, and the signal of the packet is mixed with the noise. For actually reading the received signal, whether the packet reaches the receiver has to be detected.

A method to distinguish a packet from noise is to put a preamble in the front section of the packet. Usually a PN (pseudo-noise) code preamble is used to detect a packet. Please refer to FIG. 1. FIG. 1 illustrates a detection mechanism. A packet 12 comprises a PN code preamble 13 and data 14. The PN code preamble 13 consists of five PN codes, as marked 1 to 5 in FIG. 1. Each of the PN codes 1 to 5 has the same content, which can be periodically repeated. The PN code 3 and the PN code 5 being on a different side of the PN codes 1, 2 and 4 according to the horizontal axis means that they are negative codes. The PN code preamble 13 can be represent by the following simple expression:

$$x ( n ) = {\sum }_{1} s ( k ) c ( n - Nk )$$

where x(n) represents the preamble 13, s(k) is a PSK (Phase Shift Keying) signal and c(n) represents the PN code with length N.

In prior art, there are two methods to recognize the preamble, the matching method and the correlation method. In the matching method, a received signal undergoes convolution with the conjugate of the PN code c*(−n). If the signal contains the packet with the preamble having the PN code c(n), the convolution result will obtain a peak. In FIG. 1, because there are five PN codes in the preamble 13, the convolution result of the packet 12 will show five main peaks. Moreover, since the PN codes are periodically repeated in the preamble 13, the main peaks of the convolution result are periodic. However, there can be noise peaks in the convolution result, power of a main peak usually being greater than power of a noise peak. Thus, the main peak is easily recognized by comparing the power of the main peak with the noise power. Then, the packet can be detected by inspecting the periodicity and code matching of the preamble.

In the correlation method, packet detection is performed according to a correlation of the preamble. Because two similar codes have a high correlation, but noise is usually uncorrelated to the actual signal, we can distinguish noise and the wanted code by calculating the correlation. In the preamble 13, the code length of a PN code is N bits and the PN codes are repeated, so if one received signal belongs to a PN code, the signal after N bits of the received signal is also a PN code. According to the above principle, each received signal undergoes correlation with the signal delayed by N bits. If the result of two signals shows high correlation, it means the two signals belong to PN codes and should be part of the preamble. Therefore, the packet is detected by calculating a correlation of the preamble.

Both measuring peak power and calculating the correlation of a packet preamble are methods of packet detection. However, when detecting peak power of a preamble, the input signal should undergo convolution with the conjugate of the PN sequence. If the input signal has the same PN sequence, several obvious peaks are generated. This is the result of code matching in the convolution principle. In some situations, when a PN code is short and seriously affected by embedded noise, the PN code cannot be distinguished after convolution. Input packets will fail to be detected, which is called a packet loss. Additionally, if noise appearing in the convolution result has the shape of a signal peak, a packet may be mistakenly detected when in fact the received signal is nothing but noise. This mistaken detection is called false alarm. The correlation method of packet detection also allows for some incorrect detection. In the situation of a short PN code, the correlation result is easily affected by noise and the multi-path effect, leading to wrongly distinguishing between noise and a packet. Therefore, in the prior art, methods of packet detection cannot always correctly detect a packet with a short PN code in the preamble. Thus, some packets having important information will be lost.

### SUMMARY OF INVENTION

It is therefore a primary objective of the claimed invention to provide a method of packet detection to solve the above-mentioned problems.

According to the claimed invention, a receiver receives an input signal, which comprises a packet. The packet comprises a preamble which comprises a plurality of PN codes. A method of packet detection comprises: obtaining a correlation of the input signal; detecting a peak power of the input signal; and determining if the packet is detected according to the correlation and the peak power of the input signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a detection mechanism.

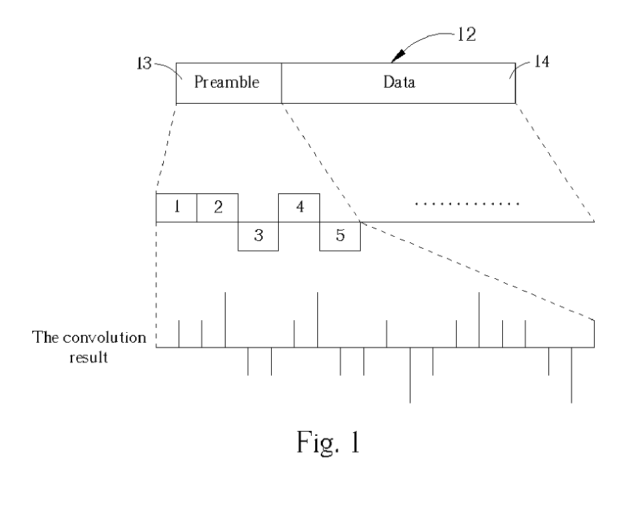

FIG. 2 illustrates a flowchart of a packet detection method according to the present invention.

FIG. 3 illustrates a flowchart of the correlation method in step 130 of FIG. 2.

FIG. 4 illustrates a flowchart of the peak detection method in the step 140 of FIG. 2.

FIG. 5 illustrates a flowchart of determining whether a packet arrives at the receiver in step 150 of FIG. 2.

FIG. 6 illustrates a flowchart of another embodiment of the packet detection method according to the present invention.

FIG. 7 illustrates a packet detecting device of the present invention.

### DETAILED DESCRIPTION

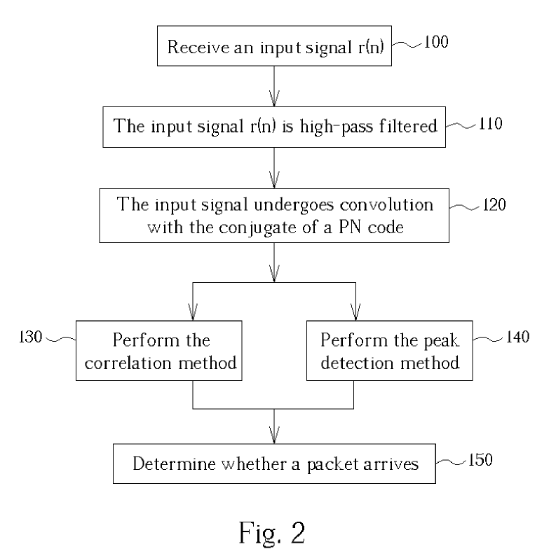

Please refer to FIG. 2. FIG. 2 illustrates a flowchart of a packet detection method according to the present invention. In step 100, an input signal r(n) is received. The input signal comprises a plurality of packets and each packet comprises a preamble for packet detection. As mentioned before, the preamble comprises several periodic PN codes, also called a PN sequence. Therefore, an original preamble of a packet can be expressed as follows:

$$x ( n ) = {\sum }_{2} s ( k ) c ( n - Nk )$$

where x(n) represents the preamble, s(k) is a PSK (Phase Shift Keying) signal and c(n) represents the PN code with length N. The signal x(n) transmitted over a multi-path channel is affected by noise and undergoes distortion and becomes the input signal r(n). Then, a receiver receives the input signal r(n) that has both the information of x(n) as well as other noise.

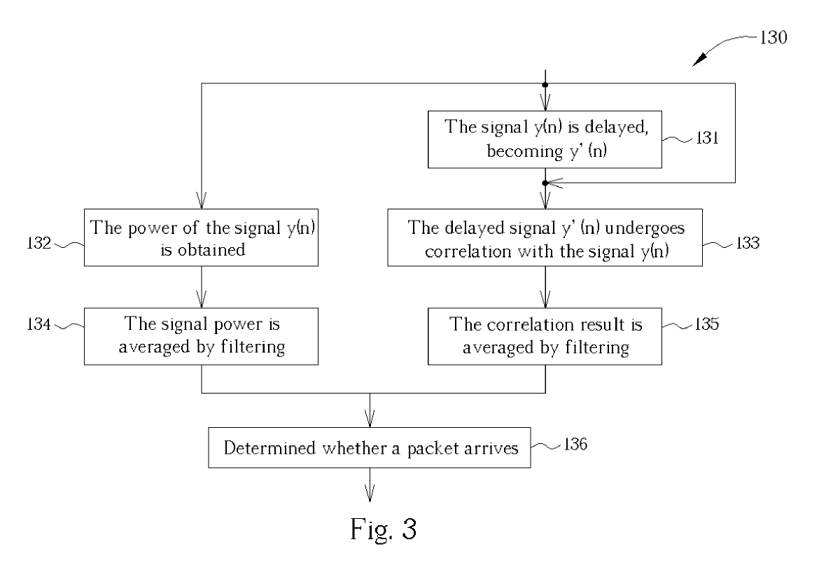

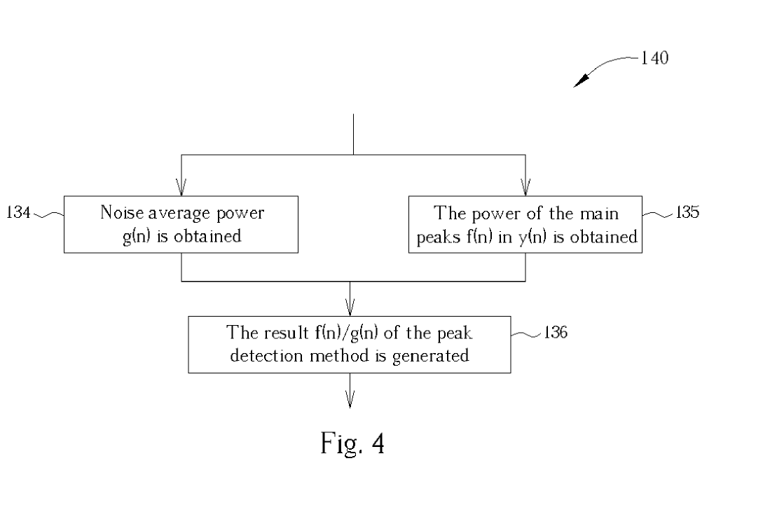

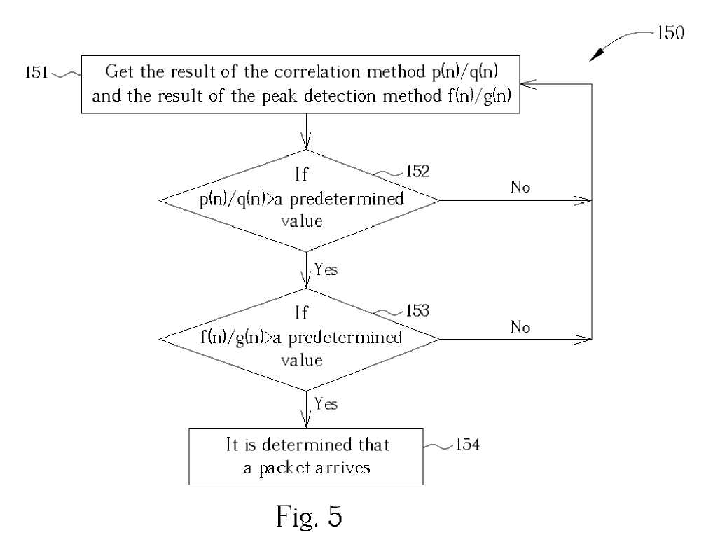

In step 110, the input signal r(n) is high-pass filtered to remove the DC portion of the input signal. The DC portion of the input signal does not contain the information of the packet, but it will affect the result of the correlation calculation of the input signal. In step 120, a convolution is performed on the input signal with the conjugate of a PN code, c*(−n). When the signal x(n) is transmitted to a receiver through a multi-path channel, the signal x(n) taking different paths with different delays will arrive at the receiver at different times. Therefore, the period of the input signal becomes ambiguous. The convolution operation makes it easier to recognize the period. In step 130, a correlation method for the input signal after the convolution operation, called y(n), is performed. In step 140, a peak detection method for the signal y(n) is performed. The results of both the correlation method and the peak detection method are used to determine if the input signal contains the packet. Theses two procedures will be described in detail with respect to FIG. 3 and FIG. 4. Whether a packet arrives at the receiver is determined in step 150, which is further described referencing FIG. 5.

Please refer to FIG. 3. FIG. 3 illustrates a flowchart of the correlation method in step 130 of FIG. 2. In step 131, the signal y(n) is delayed, becoming y″(n). If the PN code of the input signal has length N bits, the signal y(n) is delayed by N bits. The delayed signal y″(n) is correlated with the signal y(n) in step 133. In step 132, the power of the signal y(n) is obtained. In step 135 and step 134, the correlation result and the signal power are averaged by filtering, and generating a correlation result p(n) as well as an average power q(n). In step 136, the result p(n)/q(n) of the correlation method is obtained by dividing p(n) by q(n). The correlation result p(n) and the average power q(n) can be expressed as follows:

$$\begin{matrix}p ( n ) = {\vert {\sum }_{i = 0}^{- N + 1} {y}^{*} ( n + i ) y ( n - N + i ) \vert}^{2} \\ q ( n ) = {\vert {\sum }_{i = 0}^{- N + 1} {y}^{*} ( n + i ) y ( n + i ) \vert}^{2}\end{matrix}$$

Please refer to FIG. 4. FIG. 4 illustrates a flowchart of the peak detection method in the step 140 of FIG. 2. In step 141, noise average power g(n) is obtained. In step 142, the power of the main peaks f(n) in y(n) is obtained. Because the signal y(n) contains a plurality of peaks, including the main peaks which represent the desired signal and noise peaks, the main peak should be detected first. Then, the noise average power can be obtained by averaging the power of the noise peaks. In step 143, the result f(n)/g(n) of the peak detection method is generated.

Please refer to FIG. 5. FIG. 5 illustrates a flowchart of determining whether a packet arrives at the receiver in step 150 of FIG. 2. In step 151, the result of the correlation method p(n)/q(n) and the result of the peak detection method f(n)/g(n) are obtained. In step 152, if p(n)/q(n) is greater than a predetermined value, then execution of step 153 is maintained; or if p(n)/q(n) is not greater than a predetermined value step 151 is performed. In step 153, if f(n)/g(n) is greater than a predetermined value, subsequent step 154 is performed; or if f(n)/g(n) is not greater than a predetermined value, step 151 is performed. Finally, in step 154, it is determined that a packet arrives.

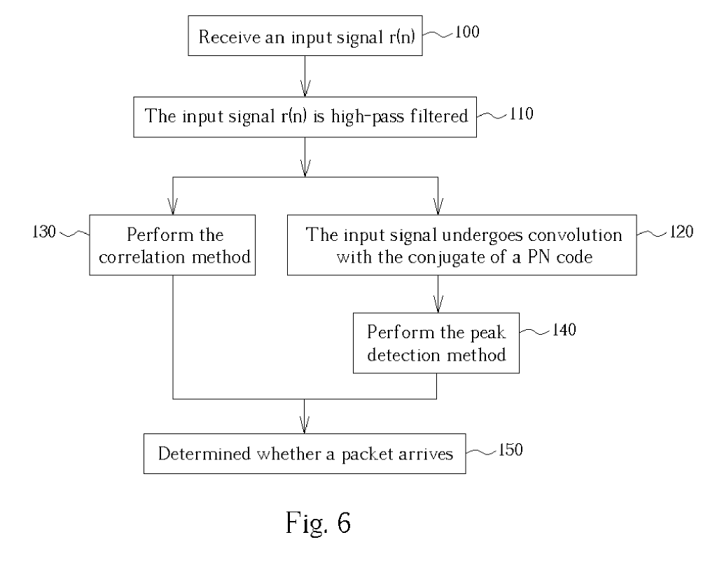

Please refer to FIG. 6. FIG. 6 illustrates a flowchart of another embodiment of the packet detection method according to the present invention. Step 120 in FIG. 2 performs a convolution operation to make the period of the preamble easily recognized. If the PSK signal s(k) is constant (that means the preamble x(n) is an identical signal), the periodicity of the input signal is obvious even when the input signal undergoes a multi-path channel effect. Therefore, it is not required to perform a convolution operation before the correlation method, step 120 in FIG. 2. In other words, the flow of the packet detection method of the present invention can be changed as FIG. 6. In step 100, an input signal is received. In subsequent step 110, the input signal r(n) is high-pass filtered. In step 120 and step 140, the input signal undergoes convolution with conjugate of a PN code, c*(−n), and then undergoes the peak detection method. In step 130, a correlation method for the input signal is performed. Finally, in step 150, whether a packet arrives at the receiver is determined.

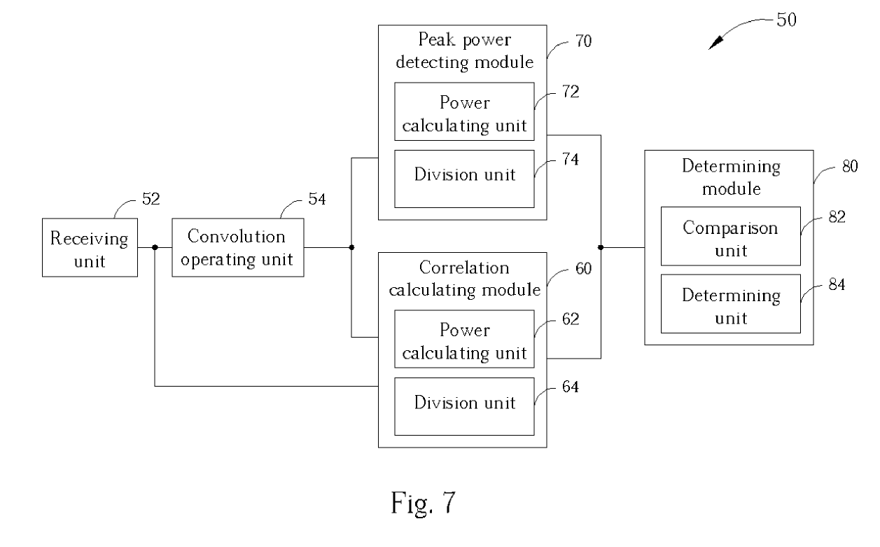

Please refer to FIG. 7. FIG. 7 illustrates a packet detecting device 50 of the present invention. The packet detecting device 50 comprises a receiving unit 52, a convolution operating unit 54, a correlation calculating module 60, a peak power detecting module 70, and a determining module 80. The correlation calculating module 60 comprises a power calculating unit 62 and a division unit 64. The peak power detecting module 70 comprises a power calculating unit 72 and a division unit 74. The determining module 80 comprises a comparison unit 82 and a determining unit 84.

The receiving unit 52 receives an input signal r(n). The input signal r(n) comprises a plurality of packets, and each packet has a preamble which comprises a plurality of PN codes. The input signal r(n) is high-pass filtered in the receiving unit 52, which outputs the signal r1(n). The signal r1(n) undergoes convolution in the convolution operating unit 54, outputting a result y(n). The correlation calculating module 60 is used to obtain the correlation of the result y(n) or the signal r1(n). In the correlation calculating module 60, the power calculating unit 62 calculates the average power of the result y(n), which relates to average power of the preamble of a packet. The division unit 64 divides the correlation of the result y(n) by the average power of the result y(n) and outputs a division signal to the determining module 80. The peak power detecting module 70 is used to detect a peak power of the result y(n). The power calculating unit 72 obtains the average power of noise of the result y(n) and the division unit 74 divides the peak power of the result y(n) by the average power of the noise and outputs a division signal to the determining module 80. The comparison unit 82 is used to compare the division signal of the peak power detecting module 70 with a predetermined value and compare the division signal of the correlation calculating module 60 with another predetermined value. Thus, if the correlation result is p(n) and the average power of the signal y(n) is q(n), and the power of the main peak is f(n) and the noise average power is g(n), the comparison unit 82 compares p(n)/q(n) with a predetermined value and f(n)/g(n) with another predetermined value. The determining unit 84 determines if the packet arrives according to comparison results of the comparison unit 82.

In addition, the division units 74 are not indispensable. Although, the comparison unit 82 determines if p(n)/q(n) is larger than a predetermined value and if f(n)/g(n) is larger than another predetermined value, it can also check if p(n)>q(n)*(a predetermined value) or f(n)>g(n)*(a predetermined value). Therefore, the division units should be replaced by the multiplication units in this situation.

In the prior art, both measuring peak power and calculating the correlation of a packet preamble are methods of packet detection. However, if a PN code is short and seriously affected by embedded noise, the PN code cannot be distinguished after undergoing convolution. A packet loss occurs. Additionally, if noise appearing in the convolution result is shaped like signal peaks, a packet can be mistakenly detected resulting in a false alarm. In the case of the correlation method for a short PN code, the correlation result is readily affected by noise and the multi-path effect, leading to wrongly distinguishing between noise and a packet. Both methods of packet detection according to prior art cannot always correctly apply to detecting a packet with short PN code in the preamble. In contrast to the prior art, the present invention combines a method of measuring peak power for packet detection and a method of calculating the correlation of a packet preamble so that a packet can be correctly detected. Therefore, the present invention improves the performance of packet detection and greatly decreases the number of packets lost and the number of false alarms.

Those skilled in the art will readily observe that numerous modifications and alterations of the device may be made while retaining the teachings of the invention. Accordingly, the above disclosure should be construed as limited only by the metes and bounds of the appended claims.

1. A method of packet detection, wherein a receiver receives an input signal, the input signal comprising a packet, and the packet comprising a preamble which comprises a plurality of pseudo-noise (PN) codes, the method comprising:
obtaining a correlation of the input signal;
detecting a peak power of the input signal; and
determining if the packet is detected according to the correlation and the peak power of the input signal.

2. The packet detection method in claim 1 further comprising filtering the input signal.

3. The packet detection method in claim 1 further comprising determining the periodicity of peaks in the preamble.

4. The packet detection method in claim 3 wherein determining the periodicity of the preamble comprises performing a convolution for a conjugate of a PN code and the PN codes to generate a processed preamble.

5. The packet detection method in claim 1 wherein to obtain a correlation of the input signal comprises obtaining a correlation of the processed preamble.

6. The packet detection method in claim 4 wherein detecting a peak power of the input signal comprises detecting a peak power of the processed preamble.

7. The packet detection method in claim 1 further comprising obtaining an average power of the preamble.

8. The packet detection method in claim 7 wherein the packet is detected when the ratio of the correlation to the average power of the preamble is larger than a predetermined value and when the ratio of the peak power to the average power of the noise is large than another predetermined value.

9. The packet detection method in claim 1 further comprising obtaining an average power of noise of the preamble.

10. The packet detection method in claim 9 wherein the packet is detected when the ratio of the correlation to the average power of the preamble is larger than a predetermined value and when the ratio of the peak power to the average power of the noise is large than another predetermined value.

11. A method of packet detection, wherein a receiver receives an input signal, the input signal comprising a packet, and the packet comprising a preamble which comprises a plurality of pseudo-noise (PN) codes, the method comprising:
obtaining a correlation of the input signal;
detecting a peak power of the input signal; and
a step for determining if the packet is detected according to the correlation and the peak power of the input signal.

12. A packet detecting device comprising:
a receiving unit for receiving an input signal, the input signal comprising a packet, the packet comprising a preamble;
a convolution operating unit connected to the receiving unit for performing a convolution of the input signal;
a correlation calculating module connected to the convolution operating unit for obtaining a correlation of the input signal;
a peak power detecting module connected to the convolution operating unit for detecting a peak power of the input signal; and
a determining module connected to the correlation calculating module and the peak power detecting module comprising a determining unit which determines if the packet is detected.

13. The packet detecting device in claim 12 wherein the correlation calculating module comprises a power calculating unit for obtaining average power of the preamble.

14. The packet detecting device in claim 13 wherein the correlation calculating module further comprises a division unit for dividing the correlation of the preamble by the average power of the preamble and outputting a division signal to the determining module.

15. The packet detecting device in claim 13 wherein the correlation calculating module further comprises a multiplication unit for multiplying the average power of the preamble by a predetermined value and outputting a multiplication signal to the determining module.

16. The packet detecting device in claim 12 wherein the peak power detecting module comprises a power calculating unit for obtaining average power of noise of the preamble.

17. The packet detecting device in claim 16 wherein the peak power detecting module further comprises a division unit for dividing the peak power of the preamble by average power of the noise and outputting a division signal to the determining module.

18. The packet detecting device in claim 16 wherein the peak power detecting module further comprises a multiplication unit for multiplying the average power of the noise by a predetermined value and outputting a multiplication signal to the determining module.

19. The packet detecting device in claim 14 wherein the peak power detecting module comprises a power calculating unit for obtaining average power of noise of the preamble.

20. The packet detecting device in claim 16 wherein the peak power detecting module comprises a power calculating unit for obtaining average power of noise of the preamble.

21. The packet detecting device in claim 19 wherein the peak power detecting module further comprises a division unit for dividing the peak power of the preamble by average power of the noise and outputting a division signal to the determining module.

22. The packet detecting device in claim 20 wherein the peak power detecting module further comprises a multiplication unit for multiplying the average power of the noise by a predetermined value and outputting a multiplication signal to the determining module.

23. The packet detecting device in claim 17 wherein the determining module comprises a comparison unit for comparing the division signal of the peak power detecting module with a predetermined value.

24. The packet detecting device in claim 14 wherein the determining module further comprises a comparison unit for comparing the division signal of the correlation calculating module with a predetermined value.

25. The packet detecting device in claim 15 wherein the determining module further comprises a comparison unit for comparing the multiplication signal of the correlation calculating module with the correlation of the preamble.

26. The packet detecting device in claim 18 wherein the determining module further comprises a comparison unit for comparing the multiplication signal of the peak power detecting module with the peak power of the preamble.

27. The packet detecting device in claim 23 wherein the determining module comprises a comparison unit for comparing the division signal of the peak power detecting module with a predetermined value.

28. The packet detecting device in claim 25 wherein the determining module further comprises a comparison unit for comparing the multiplication signal of the peak power detecting module with the peak power of the preamble.

29. The packet detecting device in claim 27 wherein the determining module further comprises a determining unit for determining if the packet arrives according to comparison results of the comparison unit.

30. The packet detecting device in claim 28 wherein the determining module further comprises a determining unit for determining if the packet arrives according to comparison results of the comparison unit.
